(19) United States
(12) Patent Application Publication
(10) Pub. No.: US 2018/0224684 A1
(43) Pub. Date: Aug. 9, 2018

(54) TOUCH DISPLAY DEVICE

(71) Applicant: Chunghwa Picture Tubes, LTD., Taoyuan City (TW)

(72) Inventor: Cheng-Feng Su, New Taipei City (TW)

(73) Assignee: Chunghwa Picture Tubes, LTD., Taoyuan City (TW)

(21) Appl. No.: 15/470,287

(22) Filed: Mar. 27, 2017

(30) Foreign Application Priority Data
Feb. 9, 2017 (CN) 201720119443.1

(51) Int. Cl. G02F 1/1333; G06F 3/041; G02F 1/1339; G02F 1/1368; G02F 1/1335

(52) U.S. Cl. CPC G02F 1/13338; G06F 3/0412; G02F 1/133514; G02F 1/1368; G02F 1/133512; G02F 1/13394

(57) ABSTRACT

Provided is a touch display device that includes a first substrate, an active component, a first insulating layer, a touch trace, a second insulating layer, a common electrode, a third insulating layer, a pixel electrode, a second substrate, and a display medium. The second insulating layer covers the first insulating layer and has a first opening that exposes the touch trace. The common electrode is disposed on the second insulating layer and fills in the first opening so as to be electrically connected to the touch trace. The pixel electrode has a plurality of slits. The second substrate has a spacer that extends towards the first substrate. The spacer is disposed above the first opening, and an orthographic projection of the spacer on the first substrate is within an orthographic projection of the first opening on the first substrate.

### CROSS-REFERENCE TO RELATED APPLICATION

This application claims the priority benefit of China application serial no. 201720119443.1, filed on Feb. 9, 2017. The entirety of the above-mentioned patent application is hereby incorporated by reference herein and made a part of this specification.

### BACKGROUND OF THE INVENTION

### Field of the Invention

The invention relates to a display device and particularly relates to a touch display device.

### Description of Related Art

A touch display device has both touch function and display function and can be categorized into an out-cell touch display device, an on-cell touch display device, and an in-cell touch display device based on the structure. Among them, the in-cell touch display device integrates the touch function inside a display panel and is the thinnest in terms of overall thickness, so that it is mostly applied to high-end products that require thin appearance.

The display panel of the in-cell touch display device includes a lower substrate (such as an active component substrate), an upper substrate (such as a color filter substrate), and a liquid crystal layer interposed between the two substrates. To ensure display quality, a spacer is provided between the two substrates so as to maintain a cell gap between the two substrates. In the in-cell touch display device, since a touch trace needs to be electrically connected to a common electrode, an opening is provided on an insulating layer above the touch trace, so that the common electrode is electrically connected to the touch trace through the opening. In order to attain cell gap uniformity, the spacer needs to be disposed on a flat surface other than the opening. However, since the liquid crystal in the vicinity of the spacer has poor alignment, a light-shielding pattern needs to be provided so as to shield the spacer and the area in its vicinity. As a result, the aperture ratio of the touch display device is reduced.

### SUMMARY OF THE INVENTION

The invention provides a touch display device that has good performance.

In the invention, a touch display device includes a first substrate, an active component, a first insulating layer, a touch trace, a second insulating layer, a common electrode, a third insulating layer, a pixel electrode, a second substrate, and a display medium. The active component is disposed on the first substrate. The first insulating layer covers the active component. The touch trace is disposed on the first insulating layer. The second insulating layer covers the first insulating layer and has a first opening that exposes the touch trace. The common electrode is disposed on the second insulating layer and fills in the first opening so as to be electrically connected to the touch trace. The third insulating layer covers the common electrode. The pixel electrode is disposed on the third insulating layer and electrically connected to the active component, wherein the pixel electrode has a plurality of slits that expose the common electrode. The second substrate has a spacer extending towards the first substrate, wherein the spacer is disposed above the first opening and an orthographic projection of the spacer on the first substrate is within an orthographic projection of the first opening on the first substrate. The display medium is disposed between the first substrate and the second substrate.

In an embodiment of the invention, the touch display device may further include a first signal line and a second signal line that are electrically connected to the active component. Here, the first signal line and the second signal line respectively extend in a first direction and a second direction that are different from each other.

In an embodiment of the invention, the touch trace may include a conductive line portion and a contact portion. The conductive line portion extends in the first direction. The contact portion is connected to the conductive line portion and extends in the second direction. Here, the first opening of the second insulating layer exposes the contact portion, and the common electrode fills in the first opening so as to be electrically connected to the contact portion of the touch trace.

In an embodiment of the invention, the contact portion of the touch trace may overlap with the active component.

In an embodiment of the invention, the active component may include a thin-film transistor. The thin-film transistor has a source electrode, a gate electrode and a drain electrode. The source electrode is electrically connected to the first signal line, the gate electrode is electrically connected to the second signal line, and the pixel electrode is electrically connected to the drain electrode. Here, the gate electrode extends outwards from the second signal line along the first direction, and the orthographic projection of the first opening on the first substrate is within an orthographic projection of the gate electrode on the first substrate.

In an embodiment of the invention, the active component may include a thin-film transistor. The thin-film transistor has a source electrode, a gate electrode and a drain electrode. The source electrode is electrically connected to the first signal line, and the gate electrode is electrically connected to the second signal line. Here, the second insulating layer further has a second opening that exposes the drain electrode, the pixel electrode fills in the second opening so as to be electrically connected to the drain electrode, and the first opening and the second opening are positioned on a same side of the second signal line.

In an embodiment of the invention, the spacer presses against a part of the third insulating layer that is located right above the first opening.

In an embodiment of the invention, the touch display device may further include a light-shielding patterned layer disposed on the second substrate and positioned between the second substrate and the display medium. The light-shielding patterned layer has a light transmission hole that exposes the pixel electrode.

In an embodiment of the invention, the touch display device may further include a color filter disposed between the second substrate and the display medium.

In an embodiment of the invention, the display medium may include a liquid crystal.

Based on the above, in the touch display device according to an embodiment of the invention, the touch trace is electrically connected to the common electrode through the first opening of the second insulating layer. The spacer is disposed above the first opening, and the orthographic projection of the spacer on the first substrate is within the orthographic projection of the first opening on the first substrate. Accordingly, the spacer can press against a flat surface on the first opening so as to enhance gap uniformity and/or pressure resistance. In particular, the spacer only occupies the position within the orthographic projection of the first opening on the first substrate. In other words, the area where a light-shielding pattern needs to be provided is reduced. As a result, the aperture ratio of the touch display device is enhanced.

To make the aforementioned and other features and advantages of the invention more comprehensible, several embodiments accompanied with drawings are described in detail as follows.

### BRIEF DESCRIPTION OF THE DRAWINGS

The accompanying drawings are included to provide a further understanding of the invention, and are incorporated in and constitute a part of this specification. The drawings illustrate exemplary embodiments of the invention and, together with the description, serve to explain the principles of the invention.

FIG. 1 is a schematic top view of a touch display device according to an embodiment of the invention.

FIG. 2 is a schematic cross-sectional view of the touch display device of FIG. 1 taken along line I-I′.

### DESCRIPTION OF THE EMBODIMENTS

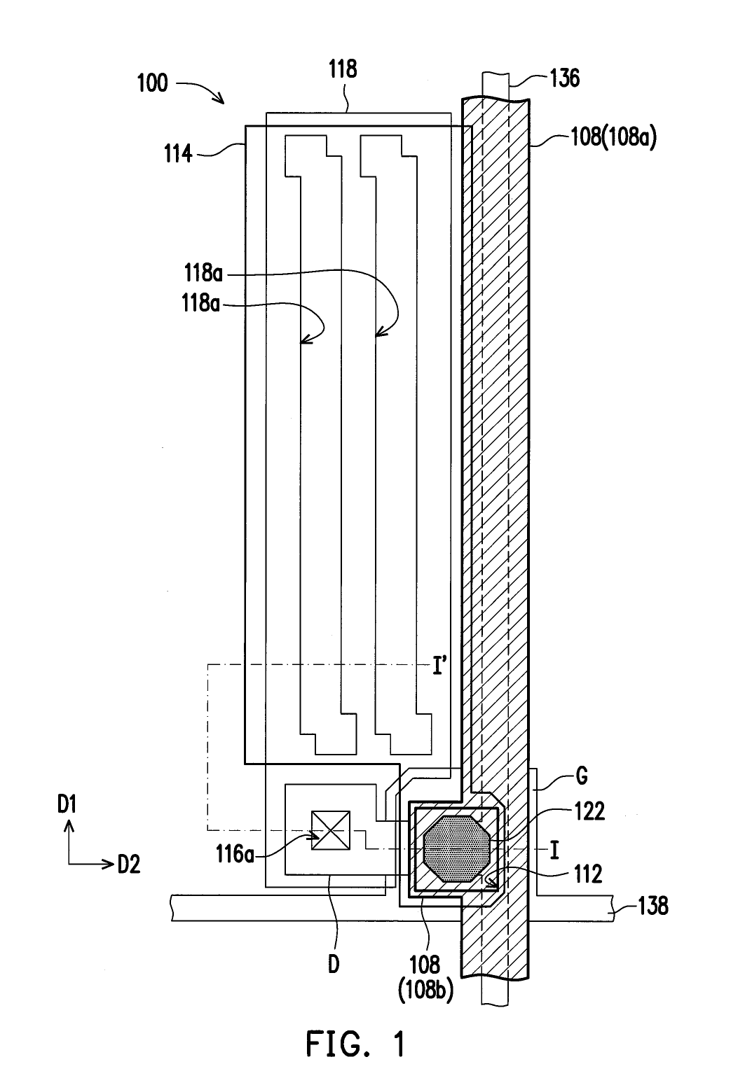

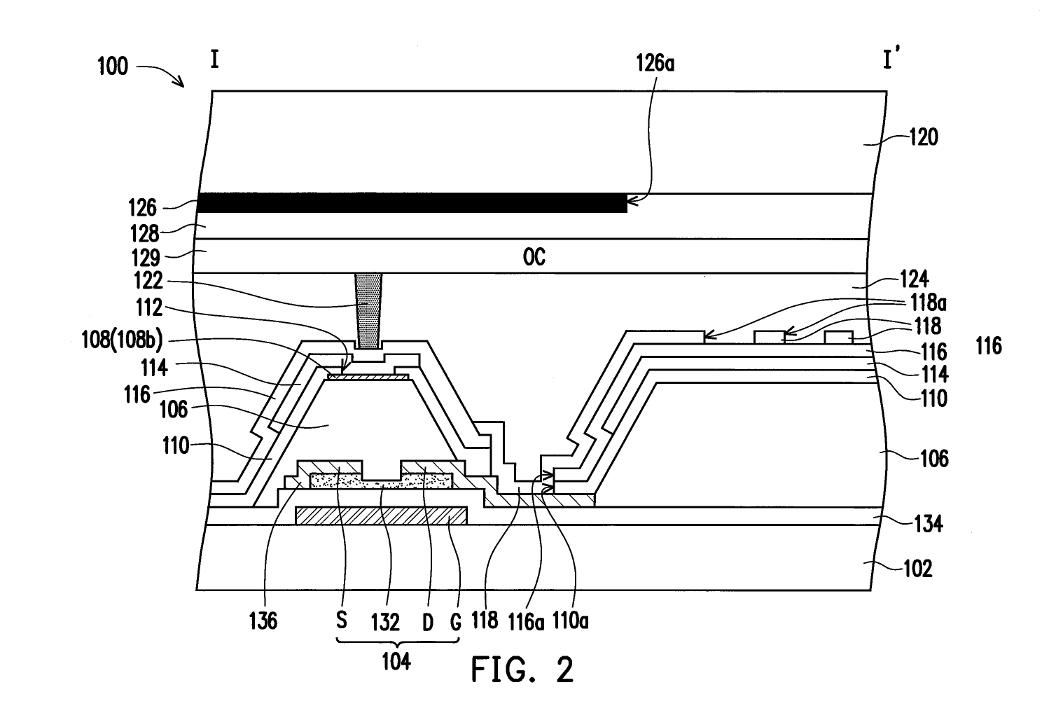

FIG. 1 is a schematic top view of a touch display device according to an embodiment of the invention. FIG. 2 is a schematic cross-sectional view of the touch display device of FIG. 1 taken along line I-I′. The accompanying drawings only show one pixel structure in this touch display device for illustration. Generally, a touch display device is constituted by a plurality of pixel structures arranged in an array. A person skilled in the art should be able to understand the structure of the touch display device recited in this invention based on recitations of the specification and drawings.

With reference to FIG. 1 and FIG. 2, a touch display device 100 includes a first substrate 102, an active component 104, a first insulating layer 106 that covers the active component 104, a touch trace 108, a second insulating layer 110, a common electrode 114, a third insulating layer 116, a pixel electrode 118, a second substrate 120, and a display medium 124.

The active component 104 is disposed on the first substrate 102. The first substrate 102 is primarily for carrying each component of the touch display device 100. The material of the first substrate 102 may be glass, quartz, an organic polymer, an opaque/reflective material (such as a conductive material, a wafer, ceramic, or other suitable materials), or other suitable materials.

In this embodiment, the active component 104 is, for example, a thin-film transistor (TFT). However, the invention is not limited thereto. In other embodiments, the active component 104 may also include other components besides the TFT, such as a capacitor, a transmission line and so on. The TFT has a source electrode S, a gate electrode G, a drain electrode D, and a semiconductor layer 132. The source electrode S and the drain electrode D are electrically connected to two sides of the semiconductor layer 132. The gate electrode G overlaps with the semiconductor layer 132. Between the source electrode S/the drain electrode D and the gate electrode G may be disposed a gate insulating layer 134, so that the source electrode S/the drain electrode D is electrically isolated from the gate electrode G. In the embodiment, the gate electrode G may be disposed between the semiconductor layer 132 and the first substrate 102. In other words, the gate electrode G may be disposed below the semiconductor layer 132, and the active component 104 may be a bottom gate TFT. However, the invention is not limited thereto. In other embodiments, the active component 104 may also be a top gate TFT or other suitable types of TFT. As shown in FIG. 1, in this embodiment, the touch display device 100 further includes a first signal line 136 and a second signal line 138 that are electrically connected to the active component 104. The first signal line 136 and the second signal line 138 respectively extend in a first direction D1 and a second direction D2 that are different from each other. The first direction D1 and the second direction D2 are, for example, perpendicular to each other, but the invention is not limited thereto. In the embodiment, the source electrode S is electrically connected to the first signal line 136, and the gate electrode G is electrically connected to the second signal line 138. In other words, the first signal line 136 is a data line, and the second signal line is a scan line. The first signal line 136 and the second signal line 138 generally consist of a metal material, but the invention is not limited thereto. In other embodiments, the first signal line 136 and the second signal line 138 may also consist of other conductive materials, such as an alloy, a nitride of a metallic material, an oxide of a metallic material, a nitrogen oxide of a metallic material, or a stack layer composed of a metallic material and other conductive materials.

The first insulating layer 106 covers the active component 104. The touch trace 108 is disposed on the first insulating layer 106. The second insulating layer 110 covers the first insulating layer 106 and has a first opening 112 that exposes the touch trace 108. Specifically, in this embodiment, the touch trace 108 may include a conductive line portion 108a and a contact portion 108b. The conductive line portion 108a extends in the first direction D1 and is approximately parallel to the first signal line 136. The contact portion 108b is connected to the conductive line portion 108a and extends in the second direction D2. The common electrode 114 fills in the first opening 112 of the second insulating layer 110 so as to be electrically connected to the touch trace 108. Specifically, in this embodiment, the first opening 112 of the second insulating layer 110 may expose the contact portion 108b of the touch trace 108, and the common electrode 114 may fill in the first opening 112 so as to be in electrical contact with the contact portion 108b of the touch trace 108. The gate electrode G extends outwards from the second signal line 138 along the first direction D1, and an orthographic projection of the first opening 112 on the first substrate 102 is within an orthographic projection of the gate electrode G on the first substrate 102. In this embodiment, the touch display device 100 may perform a touch-sensing action and a display action during alternating touch and display periods respectively. During the touch period, an assemblage of the touch trace 108 and the common electrode 114 may be viewed as a touch-sensing structure that is used to sense the touch position of a user. During the display period, an electrical potential difference between the common electrode 114 and the pixel electrode 118 may be used to drive the display medium 124 so as to make the touch display device 100 display images. In this embodiment, the contact portion 108b of the touch trace 108, the active component 104, and a spacer 122 may overlap with one another, but the invention is not limited thereto. For the sake of conductivity, the touch trace 108 generally consists of a metal material, but the invention is not limited thereto. In other embodiments, the touch trace 108 may also consist of other conductive materials, such as an alloy, a nitride of a metallic material, an oxide of a metallic material, a nitrogen oxide of a metallic material, or a stack layer composed of a metallic material and other conductive materials. The material of the first insulating layer 106 and/or the second insulating layer 110 may be an inorganic material (such as silicon oxide, silicon nitride, silicon oxynitride, or a stack layer of at least two of the foregoing materials), an organic material, or a combination thereof.

The third insulating layer 116 covers the common electrode 114. In this embodiment, the material of the third insulating layer 116 may be an inorganic material (such as silicon oxide, silicon nitride, silicon oxynitride, or a stack layer of at least two of the foregoing materials), an organic material, or a combination thereof.

The pixel electrode 118 is disposed on the third insulating layer 116 and electrically connected to the active component 104. More specifically, the second insulating layer 110 further has a second opening 110a that exposes the drain electrode D, the third insulating layer 116 has a third opening 116a that communicates with the second opening 110a, and the pixel electrode 118 fills in the third opening 116a and the second opening 110a so as to be electrically connected to the drain electrode D. The first opening 112 and the second opening 110a are positioned on a same side of the second signal line 138. The pixel electrode 118 has a plurality of slits 118a that expose the common electrode 114. The pixel electrode 118 and the common electrode 114 is separated by the third insulating layer 116 so as to be positioned on an upper surface and a lower surface of the third insulating layer 116 respectively. In other words, in this embodiment, the touch display device 110 includes a fringe field switching (FFS) display panel and the touch-sensing structure that is integrated inside the FFS display panel.

The display medium 124 is disposed between the first substrate 102 and the second substrate 120. In this embodiment, the display medium 124 is, for example, a liquid crystal but is not limited thereto. The second substrate 120 has the spacer 122 that extends towards the first substrate 102. In this embodiment, the spacer 122 is, for example, a photo spacer, but the invention is not limited thereto. The spacer 122 is disposed on the first opening 112. Specifically, in this embodiment, the spacer 122 may press against a part of the third insulating layer 116 that is located right above the first opening 112. In particular, an orthographic projection of the spacer 122 on the first substrate 102 is within the orthographic projection of the first opening 112 on the first substrate 102. Accordingly, the spacer 122 can press against a flat surface (i.e. the spacer 122 is disposed on the upper surface of a part of the third insulating layer 116 that is located right above the first opening 112). In this way, the spacer 122 may securely support a cell gap between the first substrate 102 and the second substrate 120 so as to enhance gap uniformity and/or pressure resistance of the touch display device 100.

The touch display device 100 further includes a light-shielding patterned layer 126. In this embodiment, the light-shielding patterned layer 126 is, for example, disposed on the second substrate 120 and positioned between the second substrate 120 and the display medium 124. The light-shielding patterned layer 126 has a light transmission hole 126a. The light transmission hole 126a exposes the pixel electrode 118 so that a display light beam that comes from the pixel electrode 118 may pass through the light transmission hole 126a to be transmitted into the user's eyes. Generally speaking, it is necessary to maintain a distance between the spacer 122 and the edge of the light-shielding patterned layer 126, so that the light-shielding patterned layer 126 may fully shield a part of the display medium 124 (such as a liquid crystal) that is near the spacer 122 and has poor alignment so that light leakage is reduced. The currently existing spacer (not shown) is disposed at an intersection between the first signal line 136 and the second signal line 138. The spacer 122 of this embodiment is disposed on the upper left side of the currently existing spacer, and the orthographic projection of the spacer 122 on the first substrate 102 is within the orthographic projection of the first opening 112 on the first substrate 102. Accordingly, in comparison to the currently existing spacer, the spacer 122 of this embodiment is more far apart in distance from the next pixel electrode (i.e. the pixel electrode that is located on the same row as the pixel electrode 118 of FIG. 1 and is below the pixel electrode 118), such that it is possible to design the light transmission hole 126a corresponding to the next pixel electrode to have a larger area. As a result, the aperture ratio of the touch display device 100 is enhanced.

In this embodiment, the touch display device 100 may further include a color filter 128 that is disposed between the second substrate 120 and the display medium 124. In this embodiment, the color filter 128 may be selectively disposed on the second substrate 120 and positioned between the second substrate 120 and the display medium 124. Furthermore, the touch display device 100 also includes a planarization layer 129. The planarization layer 129 covers the color filter 128 and the light-shielding patterned layer 126. The spacer 122 is disposed on the planarization layer 129. However, the invention is not limited thereto. In other embodiments, the color filter 128 may also be disposed on the first substrate 102 so as to form a color-filter-on-array (COA) structure with the active component 104, the pixel electrode 118 and so on.

In summary of the above, in the touch display device according to an embodiment of the invention, the touch trace is electrically connected to the common electrode through the first opening of the second insulating layer. The spacer is disposed above the first opening, and the orthographic projection of the spacer on the first substrate is within the orthographic projection of the first opening on the first substrate. Accordingly, the spacer can press against a flat surface on the first opening so as to enhance gap uniformity and/or pressure resistance.

Finally, it should be noted that although the embodiments are already disclosed as above, these embodiments should not be construed as limitations on the scope of the invention. It will be apparent to those ordinarily skilled in the art that various modifications and variations can be made to the disclosed embodiments without departing from the scope or spirit of this invention. In view of the foregoing, it is intended that the invention covers modifications and variations provided that they fall within the scope of the following claims and their equivalents.

1. A touch display device, comprising:
a first substrate;
an active component disposed on the first substrate;
a first insulating layer that covers the active component;
a touch trace disposed on the first insulating layer;
a second insulating layer that covers the first insulating layer and has a first opening that exposes the touch trace;
a common electrode that is disposed on the second insulating layer and fills in the first opening so as to be electrically connected to the touch trace;
a third insulating layer that covers the common electrode;
a pixel electrode disposed on the third insulating layer and electrically connected to the active component, wherein the pixel electrode has a plurality of slits that expose the common electrode;
a second substrate that has a spacer extending towards the first substrate, wherein the spacer is disposed above the first opening and an orthographic projection of the spacer on the first substrate is smaller than and within an orthographic projection of the first opening on the first substrate; and
a display medium disposed between the first substrate and the second substrate.

2. The touch display device according to claim 1, further comprising:
a first signal line and a second signal line that are electrically connected to the active component, wherein the first signal line and the second signal line respectively extend in a first direction and a second direction that are different from each other.

3. The touch display device according to claim 2, wherein the touch trace comprises:
a conductive line portion that extends in the first direction; and
a contact portion that is connected to the conductive line portion and extends in the second direction, wherein the first opening of the second insulating layer exposes the contact portion, and the common electrode fills in the first opening so as to be electrically connected to the contact portion of the touch trace.

4. The touch display device according to claim 3, wherein the contact portion of the touch trace overlaps with the active component.

5. The touch display device according to claim 2, wherein the active component comprises:
a thin-film transistor that has a source electrode, a gate electrode and a drain electrode, wherein the source electrode is electrically connected to the first signal line, the gate electrode is electrically connected to the second signal line, the pixel electrode is electrically connected to the drain electrode, the gate electrode extends outwards from the second signal line along the first direction, and the orthographic projection of the first opening on the first substrate is within an orthographic projection of the gate electrode on the first substrate.

6. The touch display device according to claim 2, wherein the active component comprises:
a thin-film transistor that has a source electrode, a gate electrode and a drain electrode, wherein the source electrode is electrically connected to the first signal line, the gate electrode is electrically connected to the second signal line, the second insulating layer further has a second opening that exposes the drain electrode, the pixel electrode fills in the second opening so as to be electrically connected to the drain electrode, and the first opening and the second opening are positioned on a same side of the second signal line.

7. The touch display device according to claim 1, wherein the spacer presses against a part of the third insulating layer that is located right above the first opening.

8. The touch display device according to claim 1, further comprising:
a light-shielding patterned layer disposed on the second substrate and positioned between the second substrate and the display medium, the light-shielding patterned layer having a light transmission hole that exposes the pixel electrode.

9. The touch display device according to claim 1, further comprising:
a color filter disposed between the second substrate and the display medium.

10. The touch display device according to claim 1, wherein the display medium comprises a liquid crystal.
